(19) United States
(12) Patent Application Publication
(10) Pub. No.: US 2011/0181462 A1
(43) Pub. Date: Jul. 28, 2011

(54) System and Method for Positioning with GNSS Using Multiple Integer Candidates

(75) Inventor: David Gary Lawrence, Santa Clara, CA (US)

(73) Assignee: David Gary Lawrence, Santa Clara, CA (US)

(21) Appl. No.: 12/692,481

(22) Filed: Jan. 22, 2010

(51) Int. Cl. G01S 19/43

(52) U.S. Cl. 342/357.26

(57) ABSTRACT

Methods and systems find position solutions using GNSS carrier phase. A plurality of integer cycle ambiguity candidates associated with the carrier phase are found as a function of corrected carrier phases. Positions and position error estimates are derived from the plurality of integer cycle ambiguity candidates.

### BACKGROUND

The present invention relates to navigation systems. In particular, it relates to a system and method for finding position from measurements of the carrier phase signals from Global Navigation Satellite System (GNSS) satellites.

GNSS RTK processing typically requires a step of cycle ambiguity resolution to achieve the positioning accuracy potentially achievable from the high precision carrier phase measurements. However, during marginal multipath or atmospheric conditions and over longer baselines, it is often difficult to resolve the cycle ambiguities for all satellites on all frequencies. Early RTK algorithms either resolved all double difference cycle ambiguities or did not leverage the integer nature of the ambiguities at all. RTK solutions were either “fixed” (if all integers were resolved) or “float” (if all integers were treated as floating, non-integer biases). Many applications have accuracy requirements between what is provided by fixed and float solutions, but with only those two options available, such applications have to wait for RTK fixed status. Therefore, there is a need for a solution that provides the high availability of RTK float and some of the accuracy improvements offered by rounding all of the cycle ambiguities. Existing partial ambiguity resolution techniques attempt to round fewer integers than the total number of unknown ambiguities to provide such a solution. However, because the common approaches to partial ambiguity resolution put artificial constraints on the results, they may exclude better results.

As the number of satellites and the number of frequencies increase with new constellations and modernization efforts, the number of cycle ambiguities to resolve will increase. The probability of correctly rounding all of the integers can decrease due to the higher number of integers to round. This effect will be compounded by larger phase errors over the longer baselines that will be used as more satellites and frequencies become available.

### BRIEF SUMMARY

The present invention is defined by the following claims, and nothing in this section should be taken as a limitation on those claims.

In one embodiment, a set of integer candidates is identified and a linear constraint on the integers consistent with all candidates in that set is found. A position solution is found subject to that linear constraint.

In another embodiment, the number of integers is reduced before identifying a set of integer candidates. A position solution is then found as a function of a plurality of these integer candidates.

### BRIEF DESCRIPTION OF THE DRAWINGS

The components and the figures are not necessarily to scale, emphasis instead being placed upon illustrating the principles of the invention.

FIG. 1 is a block diagram of a system that can be used to carry out a method for finding position in a global navigation satellite system in accordance with some embodiments.

FIG. 2 is a flow chart illustrating positioning operations in accordance with some embodiments.

### DETAILED DESCRIPTION OF THE DRAWINGS AND PRESENTLY PREFERRED EMBODIMENTS

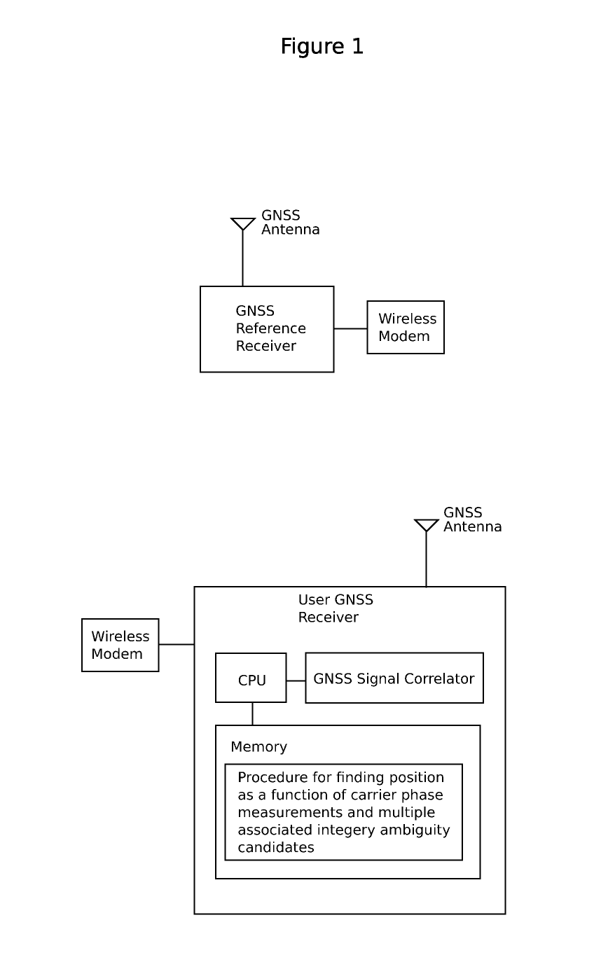

In accordance with some embodiments, FIG. 1 shows a system comprising one or more GNSS reference receivers and a user GNSS receiver. Each receiver is connected to a GNSS antenna and is operable to track carrier phases from a plurality of GNSS satellites. Additionally, each receiver is connected to a wireless modem such as a radio modem, cellular modem, satellite data modem, or other hardware capable of communicating data in at least one direction between the two receivers. In some embodiments, the GNSS reference receiver(s) sends carrier phase corrections through the wireless modem link to the user GNSS receiver. The carrier phase corrections may be RTCM phases or phase corrections, CMR phase data format, proprietary format corrections, or another information format capable of correcting carrier phases for errors common between the two receivers such as satellite clock and atmospheric errors. The user GNSS receiver comprises a CPU with attached memory and a GNSS signal correlator operable to measure carrier phases from a plurality of GNSS satellites for one or more frequencies. The memory contains instructions for finding the position of the user GNSS antenna as a function of the carrier phase measurements and a plurality of integer cycle ambiguity candidates derived from the user carrier phase measurements and the carrier phase correction data from the GNSS reference receivers.

In some embodiments, the reference receiver is a single receiver. In other embodiments, information from a network of receivers is combined to provide carrier phase corrections. In some embodiments, the communication is reversed and carrier phase measurements from the receiver associated with the position to be found are sent to a reference receiver or a phase processing facility.

In some embodiments, the carrier phases for the reference receiver are subtracted from the corresponding carrier phases from the roving receiver to form corrected carrier phases. Additionally, in some embodiments, one satellite carrier phase is subtracted from all of the other satellites at each frequency to form a double difference measurement. The linearize differetial carrier phase measurement equation can be expressed as in equation 1.

\vec{φ}=G\vec{x}+\vec{N}+\tilde{φ} (1)

where:

\vec{φ} is the double difference carrier phase measurement,

G is the double difference geometry matrix with n*m rows and three columns,

\vec{x} is the differential position,

\vec{N} is the double difference integer cycle ambiguity vector, and

\tilde{φ} is the double difference carrier phase measurement error.

n is the number of satellites minus one, and

m is the number of frequencies.

Note that the terms above are defined for double difference phase processing, but single difference processing can also be used in some embodiments. In single difference processing, \vec{x} will contain a differential receiver clock term in addition to differential position. Those skilled in the art will understand how to perform single difference and double difference processing.

According to some embodiments, a floating estimate of the integer state is maintained by applying code phase and carrier phase measurement updates to an estimator. An estimate of the error and correlation of error in that floating estimate is also maintained as a covariance matrix, information matrix, or other way of expressing error and error correlation. Error contributions and correlation of the measurement error sources, including code phase multipath, carrier phase multipath, differential ionosphere and troposphere error, linearization errors, satellite position error and measurement noise are modeled and reflected in the covariance matrix for the integer cycle ambiguity estimate state.

The differential code phase measurement equation can be expressed as in equation 2.

\vec{Φ}=G\vec{x}+\tilde{Φ} (2)

where:

\vec{Φ} is the double difference code phase measurement, and

\tilde{Φ} is the double difference code phase measurement error.

If equation 2 is subtracted from equation 1, equation 3 can be used to initialize and update an estimate of the integer ambiguities.

\vec{φ}−\vec{Φ}=\vec{N}+\tilde{φ}−\tilde{Φ} (3)

Similarly, if equation 1 is premultiplied by the left null space of the geometry matrix, equation 4 is of a form that can be used to update the integer estimate.

L\vec{φ}=LG\vec{x}+L\vec{N}+L\tilde{φ}

L\vec{φ}=L\vec{N}+L\tilde{φ} (4)

In some embodiments, models of the various error sources are used to correct the measurements and/or to model the magnitude of and correlation between the errors (or residual errors after applying corrections). For example, several models of tropospheric delay error are known to those skilled in the art. These models can be used to correct the phase errors and to estimate the magnitude of the residual errors after applying the corrections. The correlation between residual troposphere errors for the same satellite on different frequencies is known because troposphere delay is equal for each GNSS frequency. Similarly, models exist for ionospheric delay. However, the ionospheric delay errors for the same satellite at different frequencies is approximately inversely proportional to the square of the frequencies. Implementation details of such an estimator and how to model errors and their correlation are understood by those skilled in the art.

In some embodiments, a linear constraint on the integer cycle ambiguities is found. A linear constraint on a set of integer ambiguities can be written as in equation 5:

$${k}^{->} = J [ \begin{matrix}{N}_{11} \\ ⋮ \\ {N}_{1 m} \\ ⋮ \\ {N}_{n 1} \\ ⋮ \\ {N}_{nm}\end{matrix} ] ≡ J {N}^{->} \qquad ( 5 )$$

where:

J is an arbitrary matrix with a number of columns equal to the number of integer ambiguities and the number of rows less than or equal to the number of columns.

\vec{k} is a vector of constraint values with a dimension equal to the number of rows of J,

Nᵢⱼ is the ambiguity for satellite i for frequency j,

A linear constraint is defined here to be a complex constraint if the matrix J cannot be expressed without having a least one row with non-zero entries for columns corresponding to an integer ambiguity associated with at least three satellites. Note that in this context, complex is not related to imaginary numbers; it is to distinguish the constraint from a simple constraint. A simple constraint is one that can be expressed as rounding integers associated with a specific satellite (or pair of satellites in the case of double difference) or multiple frequency combination integers associated with one satellite or a double difference pair.

In some embodiments, a linear constraint is found as a function of a plurality of integer candidates. Typically, the integer least squares (ILS) solution is one of the candidates. Given a floating estimate of the integers, ILS finds the integer solution that solves this expression:

$${{N}^{->}}_{1} ≡ {min}_{\breve{N} ∈ Z} [ {( \hat{N} - \breve{N} )}^{T} {Q}_{\hat{N}}^{- 1} ( \hat{N} - \breve{N} ) ] \qquad ( 6 )$$

where:

\hat{N} is the floating estimate of the integer cycle ambiguities

Q_{\hat{N}} is the covariance matrix for the floating estimate

In some embodiments, the Least-squares AMBiguity Decorrelation Adjustment (LAMBDA) method may be used to search for the ILS solution using transformed floating ambiguities (Teunissen, 1994). In some embodiments, a modified LAMBDA (MLAMBDA) method for integer least-squares estimation is used. The MLAMBDA includes a modified Z matrix reduction process and modified search process (X. W Zhang, 2005).

A plurality of integer candidates can be found using the LAMBDA search methods or other methods. The confidence in the most likely of those candidates may not high enough to meet the requirements for a given application.

If one assumes a gaussian error distribution, the probability density function for the floating estimate of the integers can be expressed as:

$$\sqrt{( \frac{1}{{( 2 π )}^{N} \vert {Q}_{\hat{N}} \vert} )} exp ( \frac{- {( {N}^{->} - \hat{N} )}^{T} {Q}_{\hat{N}}^{- 1} ( {N}^{->} - \hat{N} )}{2} ) \qquad ( 7 )$$

where N is the number of integers.

In determining the confidence of candidates, the probability ratio between candidates can be approximated from the ratio of the gaussian probability density function as in equation 8. This ratio is a measure of the relative confidence of two integers.

$$\frac{P ( {{N}^{->}}_{i} )}{P ( {{N}^{->}}_{j} )} = \frac{exp ( \frac{- {( {{N}^{->}}_{i} - \hat{N} )}^{T} {Q}_{\hat{N}}^{- 1} ( {{N}^{->}}_{i} - \hat{N} )}{2} )}{exp ( \frac{- {( {{N}^{->}}_{j} - \hat{N} )}^{T} {Q}_{\hat{N}}^{- 1} ( {{N}^{->}}_{j} - \hat{N} )}{2} )} \qquad ( 8 )$$

An approximation to the absolute probability of the candidates can be found by truncating the series in equation 9.

$$P ( {{N}^{->}}_{i} ) = \frac{exp ( \frac{- {( {{N}^{->}}_{i} - \hat{N} )}^{T} {Q}_{\hat{N}}^{- 1} ( {{N}^{->}}_{i} - \hat{N} )}{2} )}{{\sum }_{k = 1}^{∞} exp ( \frac{- {( {{N}^{->}}_{k} - \hat{N} )}^{T} {Q}_{\hat{N}}^{- 1} ( {{N}^{->}}_{k} - \hat{N} )}{2} )} \qquad ( 9 )$$

If the ratio in equation 8 for the first and second candidates is too small, it means that the second most likely candidate cannot be rejected as a potential solution subject to the confidence levels required for the application. Either of the first two most likely candidates could be the right solution.

In one embodiment, a linear constraint that is the same for each of the two most likely candidates is found as in equation 10.

\vec{k}=J\vec{N}₁=J\vec{N}₂ (10)

\vec{0}=J(\vec{N}₂−\vec{N}₁) (11)

Equation 11 can be used to solve for J . Although there are many possible solutions, the ones that maximize the rank of J are of most interest because they will provide the most information about the integers. Specifically, they will constrain the integers to be on the line defined by the two most likely candidates. Any basis for the left nullspace of (\vec{N}₂−\vec{N}₁) is a such a solution:

J=leftnull(\vec{N}₂−\vec{N}₁) (12)

Either of the two most likely candidates can be used to find the constraint vector:

\vec{k}=J\vec{N}₁ (13)

This solution is independent of any parameterization that may performed as part of the search process. Parameterization may nevertheless be used to improve the efficiency of finding the most likely candidates.

In some embodiments, if there isn't sufficient confidence in the first two candidates, more candidates may be used. If any one of the first p candidates could be the correct solution, equations 10, 11, and 12 can be extended as in equations 14, 15, and 16. Equation 14 requires that the linear constraint yields the same result for all of the first p candidates. A constraint is defined here to be the same for a set of p candidates if equation 14 is true for that set of candidates.

\vec{k}=J\vec{N}₁=J\vec{N}₂= . . . =J\vec{N}ₚ (14)

\vec{0}=J(\vec{N}₂−\vec{N}₁)= . . . =J(\vec{N}ₚ−\vec{N}₁) (15)

Θ≡[\vec{N}₂−\vec{N}₁ . . . \vec{N}ₚ−\vec{N}₁]

J=leftnull(Θ) (16)

The probability that the constraint equation is correct is not just the sum of the probabilities of the individual candidates that are used to find the constraint matrix. It is the sum of the probabilities of all integers in the subspace defined by that constraint matrix.

In some embodiments, a solution can be defined as a function of the required probability of correct fix (PCF) or its complement, the probability of incorrect fix (PIF). The required PCF will be defined as PCR and the required probability of incorrect fix will be defined as PIR:

PCF≧PCR

PIF≦PIR (17)

There may be many constraints that satisfy expression 17. In some embodiments, the constraint that satisfies expression 17 while minimizing a cost function of the position covariance is used. In some embodiments, the cost function is position error in one direction (eg, east, north, or up, or perpendicular to the direction of travel). In other embodiments, the cost function is the position error in two directions (eg, the error in a horizontal plane). In other embodiments, the cost function is related to three dimensional position error.

In some embodiments, to select the integer candidates to use in equation 16, a confidence for each candidate is found by approximating the probability that each candidate is correct.

In some embodiments, all combinations of integer candidates with combined probabilities totaling more than PCR are found.

In some embodiments all integers candidates with individual probabilities greater than or equal to PIR are selected. If the sum of those probabilities is greater than PCR, a constraint is found using equation 16.

In some embodiments, if the sum of the probabilities of all candidates in the subspace defined by those candidates with probability greater than PIR is not greater than PCR, a search for combinations of the remaining candidates that increase the total probability to be greater than PCR. If multiple such combinations exist, the combination that minimizes a position cost function is selected.

Given the constraint vector and matrix, one can apply the information in various ways. In one embodiment the constraint is applied as a measurement update with very small measurement error to the floating estimate of the integers. The integers estimates are still treated as floating values, but they have small variances and are effectively integers.

In another embodiment, the position is found subject to the constraint by pre-multipling the carrier phase measurement equation by the constraint matrix. After pre-multiplying equation 1 by the constraint matrix, the carrier phase measurement equation can be rewritten:

J\vec{φ}−\vec{k}=JG\vec{x}+J\tilde{φ} (18)

Assuming the matrix JG has a rank of 3, equation 18 can be solved for position using weighted least squares techniques.

\vec{z}≡J\vec{φ}−\vec{k}

H≡JG

R≡JE(\tilde{φ}\tilde{φ}^{T})J^{T}

\hat{x}=(H^{T}R⁻¹H)⁻¹H^{T}R⁻¹\vec{z} (19)

Existing partial ambiguity resolution techniques can also be expressed as linear constraints on the integers. One can classify different methods of ambiguity resolution based on whether the constraint matrix is a function of only the floating covariances or of both the covariances and the estimate itself. That is, which of the following equations applies:

J=f(Q_{\hat{N}}) (20)

J=f(Q_{\hat{N}},\hat{N}) (21)

Note that for both classes, the constraint values are functions of the estimates.

\vec{k}=f(Q_{\hat{N}},\hat{N}) (22)

However, for the purposes of classification, the functional dependence of the constraint matrix is considered, not the dependence of the constraint vector.

Approximating the probabilities that integer candidates are correct can be computationally expensive. In some embodiments, the computational complexity is reduced by finding only ratios of probabilities or by decreasing the number of integers.

In some embodiments, the ratio between the probability of most likely candidate and the Mth most likely candidate is found and if that ratio is greater than a threshold, the first M or M−1 candidates are used to find a linear constraint using equation 16.

In some embodiments, the ratio of the sum of probabilities of the first M candidates and the next R candidates is found and if that ratio is greater than a confidence threshold, the first M candidates are used to find a linear constraint using equation 16.

In some embodiments, a subset of the integer states are discarded after transforming the integer ambiguity vector using a unimodular transformation such as the transformation in the LAMBDA or MLAMBDA methods. In this case, a solution of this form can be sought:

\vec{k}=J[0I]Z\vec{N} (23)

where:

Z is a unimodular transformation matrix, sorted such that the transformed integers decrease in covariance, and

I is an identity matrix with dimension less than the original number of integer states.

To do this, one can define a new integer state:

\vec{N}′=[0I]Z\vec{N}

Q_{\hat{N}′}=[0I]ZQ_{\hat{N}}Z^{T}[0I]^{T} (24)

Then, a linear constraint on the reduced dimension integer state can be found using equation 16. Integer space reduction using a unimodular transformation followed by discarding one or more integers in the transformed space will be referred to as partial bootstrapping.

In some embodiments, when multiple frequencies are available, some integer states are removed by forming linear combinations of multiple frequencies for some or all of the satellites before searching for integer candidates and using equation 16. For example, the GPS L1 and L2 frequencies could be subtracted to form a wide lane combination, thereby reducing the dimension of the integer space by half. Other existing and planned GNSS frequencies include GPS L5 and Galileo E5b and E6. In some embodiments, two combinations of three frequencies are formed to reduce the dimension of the integer space by one third. Many combinations of GNSS frequencies are known to those skilled in the art. Any of these combinations or other integer combinations of frequencies may be used to reduce the dimension of the integer space. In some embodiments, a linear combination of frequencies is performed on a subset of satellites. For example, multi-frequency combinations may be formed only for satellites below an elevation mask. In some embodiments different multiple frequency combinations are formed on different sets of satellites.

In some embodiments, both multiple frequency combinations and unimodular transformations are applied to reduce the dimension of the search space before finding integer candidates.

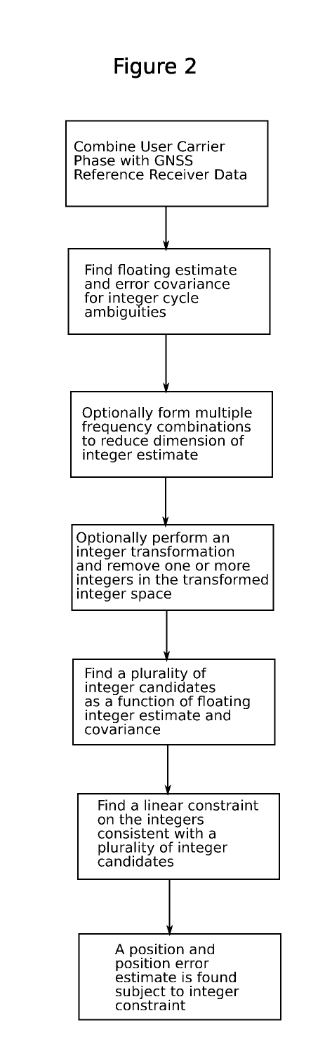

FIG. 2 shows a flow chart of major operations performed in accordance with some embodiments. Carrier phase information from a user GNSS receiver is combined with information derived from carrier phases from one or more GNSS reference receiver.

A floating estimate and associated covariance matrix of integer cycle ambiguities is derived from the carrier phases.

Multiple frequency combinations are optionally performed to reduce computational complexity. This optional step may be performed on the measurements before the estimator or on the estimate after the estimator.

A unimodular transformation is optionally performed and the integer state reduced to a smaller dimension by removing transformed integers with high covariance to reduce computational complexity.

A plurality of integer candidates is found as a function of the floating integer estimate and covariance.

A linear constraint on the integers that is the same for all of the plurality of integer candidates is found.

A position solution and position error estimate are found as function of the linear constraint on the integers and the carrier phases.

While the invention has been described above by reference to various embodiments, it should be understood that many changes and modifications can be made without departing from the scope of the invention. It is therefore intended that the foregoing detailed description be regarded as illustrative rather than limiting, and that it be understood that it is the following claims, including all equivalents, that are intended to define the spirit and scope of this invention.

I(We) claim:

1) A system for determining position, the system comprising:
a) a receiver configured to receive GNSS satellite signals for one or more frequencies and measure carrier phases for those signals,
b) a processor and a memory coupled to the processor, the memory storing instructions for finding a plurality of integer candidates as a function of the measured carrier phases, finding a complex linear constraint on the integers as a function of the plurality of integer candidates, and finding a position as a function of the complex linear constraint on the integers and the measured carrier phases.

2) The system of (1) wherein finding a multiple satellite linear combination is found by finding a linear constraint that is the same for each of the plurality of integer candidates.

3) The system of (2) wherein the linear constraint is found as a function of the null space of a matrix derived from the plurality of integer candidates.

4) A method for finding position, the method comprising:
a) measuring carrier phase for a plurality of GNSS satellites on one or more frequencies
b) combining the carrier phases with information from one or more GNSS reference stations
c) finding a plurality of integer candidates as a function of the carrier phases
d) finding an estimate of confidence or relative confidence for each integer candidate
e) identifying a group of more than one of the plurality of integer candidates as a function of the confidence in the integer candidates
f) forming a complex linear constraint on the integers, said linear constraint being the same for all candidates in the group.
g) finding an estimate of position as a function of the linear constraint and the carrier phases

5) The method of claim (4) wherein an estimate of error in the position is found as a function of the linear constraint.

6) The method of claim (4) wherein the step of finding a plurality of integer canditates comprises finding a floating estimate of integer cycle ambiguities and an estimate of error in that estimate as a function of the carrier phases and then finding the plurality of integer candidates as a function of the floating estimate.

7) The method of claim (6) wherein the floating estimate is a function of a model of atmospheric delay errors.

8) The method of claim (4) wherein the complex linear constraint by found by finding a basis for the null space of a matrix that is a function of the group of integer candidates.

9) A method for finding position, the method comprising:
a) measuring carrier phase for a plurality of GNSS satellites on one or more frequencies
b) combining the carrier phases with information from one or more GNSS reference stations
c) finding an estimate of the integer cycle ambiguities associated with the resulting combination
d) finding an estimate of error and error correlation for the estimate of integer cycle ambiguities
e) reducing the dimension of the ambiguity space to less than (N−1)*M where N is the number of satellites and M is the number of frequencies, said reduction being accomplished by forming combinations of frequencies and/or by partial bootstrapping.
f) finding a plurality of integer candidates for the reduced dimension ambiguity space
g) finding an estimate of confidence for each integer candidate
h) finding an estimate of position as a function of one or more of the plurality of integer candidates
i) finding an estimate of error in that position as a function of more than one of the plurality of the integer candidates

10) The method of claim (9) wherein the reduction of dimension is performed using partial bootstrapping wherein one or more of the integers with the highest variance in the transformed transformed integer space is removed.

11) The method of claim (9) wherein the carrier phase for more than one of frequency is measured and the reduction of dimension is performed by forming combinations of frequencies.

12) The method of claim (9) wherein finding the position comprises the steps of:
a) identifying a group of more than one of the plurality of integer candidates as a function of the confidence in the integer candidates
b) finding a linear constraint on the integers, said linear constraint having the property that all candidates in the group yield the same result after application of the linear constraint

13) The method of claim (12) wherein the linear combination is found by removing all integers that are not all identical throughout the group

14) The method of claim (12) wherein the linear constraint is complex.

15) The method of claim (12) wherein the linear constraint is found by finding the null space of a matrix that is a function of the group of candidates.

16) The method of claim (9) wherein the estimate of error of the integer cycle ambiguities is a function of a model of atmospheric delay errors.
